(19) United States
(12) Patent Application Publication
(10) Pub. No.: US 2025/0130783 A1
(43) Pub. Date: Apr. 24, 2025

(54) METHODS FOR IMPROVING THE MEMORY ALLOCATION OF LLM-GENERATED CODE

(71) Applicant: Robert Bosch GmbH, Stuttgart (DE)

(72) Inventors: Christopher Huth, Heilbronn (DE); Jesko Hecking-Harbusch, Leonberg (DE); Jochen Quante, Ludwigsburg (DE); Matthias Woehrle, Bietigheim-Bissingen (DE); Maximilian Schlund, Stuttgart (DE); Sebastian Ernesto Sierra Loaiza, Stuttgart (DE)

(21) Appl. No.: 18/814,794

(22) Filed: Aug. 26, 2024

(30) Foreign Application Priority Data
Oct. 19, 2023 (EP) 23 20 4627.6

(51) Int. Cl. G06F 8/41; G06F 8/35

(52) U.S. Cl. CPC G06F 8/4434; G06F 8/35

(57) ABSTRACT

A method for improving the memory allocation of code generated using a language model. The method includes: providing a program code generated using a language model, if a new version of the program code is available; generating an executable file using compilation and instrumentation, wherein a memory sanitizer inserts instructions into the program code and/or the executable file; execution of fuzzing by a fuzzer, wherein the fuzzer injects inputs into the executable file; monitoring the memory performance and optionally runtime information, the behavior and/or the output of the executable file; storing metadata generated from the allocated and freed memory in a memory metadata database, wherein the metadata are based on the instructions and are stored when the executable file is generated and/or when the fuzzing is executed; outputting the program code if no memory performance degradation or other errors are found.

### CROSS REFERENCE

The present application claims the benefit under 35 U.S.C. § 119 of European Patent Application No. EP 23 20 4627.6 filed on Oct. 19, 2023, which is expressly incorporated herein by reference in its entirety.

### BACKGROUND INFORMATION

Increasingly, program code is generated by means of language models, such as large language models (LLMs). This can be done for example as part of a language translation or automated program code translation or code refactoring.

The use of approaches for automated code generation, for example from LLMs, always brings challenges; for example, there is no guarantee that the code is correct, and there is no guarantee that the performance improves. For example, improvements may be generated for small code fragments, but this approach is not practical for larger code bases.

Working with larger code bases diminishes the usability of certain static methods, such as abstract interpretation, since correctness guarantees cannot be computed in a reasonable time or approximation is required, which then leads to over-approximation errors. In addition, static methods are hardly suitable for measuring software performance, e.g., memory consumption.

Sanitizers can recognize all types of runtime errors. Here, the focus is particularly on memory errors and memory inefficiencies that occur during the runtime. Dangers arise in particular in the case of partially initialized variables. The values of variables can sometimes be determined only when they are initialized, e.g., by a write operation. The C++14 standard allows indeterminate passing of values in some cases so that sanitizers generally report many false positives. Partially initialized variables can become vulnerable if the uninitialized value exceeds a confidence interval.

Problems with uninitialized memory can often be solved with memory sanitizers. However, LLM-based code generators may produce code that is not optimal but still functionally correct (for example, increased heap memory allocation). Tests, such as unit tests for verifying LLM-based code optimizations, can hardly detect such inefficiencies, or cannot detect them at all.

### SUMMARY

A first general aspect of the present invention relates to a method for improving the memory allocation of code generated by means of a language model.

According to an example embodiment of the present invention, the method comprises:
providing a program code generated by means of a language model,
   if a new version of the program code is available,
generating an executable file by means of compilation and instrumentation, wherein a memory sanitizer inserts instructions into the program code and/or the executable file,
executing fuzzing by means of a fuzzer, wherein the fuzzer injects inputs into the executable file,
monitoring the memory performance and optionally runtime information, the behavior and/or the output of the executable file,
storing metadata generated from the allocated and freed memory in a memory metadata database, wherein the metadata are based on the instructions and are stored when the executable file is generated and/or when the fuzzing is executed;
outputting the program code if no memory performance degradation or other errors are found.

A second general aspect of the present invention relates to a method for training a language model configured to automatically generate program code.

According to an example embodiment of the present invention, the method comprises:
inputting a source code into a language model and generating a program code,
improving the program code by means of the method according to the first general aspect,
generating a reward for the language model, wherein the reward is based on the monitoring of the memory performance and optionally runtime information, the behavior and/or the output of the executable file and/or the metadata,
updating weights of the language model with the value of the reward.

A third general aspect of the present invention relates to a computer system designed to execute the method according to the first and/or the second general aspect of the present invention (or an embodiment thereof).

A fourth general aspect of the present invention relates to a computer program designed to execute the method according to the first general aspect of the present invention (or an embodiment thereof).

A fifth general aspect of the present invention relates to a computer-readable medium or signal which stores and/or contains the computer program according to the fourth general aspect of the present invention (or an embodiment thereof).

The techniques of the first, second, third, fourth and fifth general aspects can have one or more of the following advantages in some situations.

The present invention uses the dynamic software testing method fuzzing, in particular fuzzing enhanced with a sanitizer. A memory sanitizer is used in order to make the memory behavior (for example allocation, freeing and their sizes) visible. Fuzzing is used in order to cover as many different paths as possible in the software to be tested. The observed memory behavior can be used to assess whether the code generated by means of LLM has become more powerful, which makes a feedback loop possible for better prompting for newer code generated by means of an LLM.

The present invention makes it possible to test software without existing tests, such as unit tests for checking whether the generated code patches are functionally correct. These tests generally do not measure memory consumption, nor can they measure an improvement in memory performance. Existing tests will at best fail if too much memory is used. The use of LLMs for code generation always carries the risk that the generated code contains nonsensical or poorly functioning code. The present invention enables iterative learning for improving LLM-generated code over multiple generations.

A further problem for LLMs is refactoring and optimizing code for various goals. A typical allocation of heap memory is to free the heap memory after all operations on the data have been completed. On devices with limited storage space, such as IoT devices, refactoring might be useful in order to reuse heap memory between individual data operations so that not every variable needs to be kept in the memory. The present invention makes it possible to monitor and improve memory allocation in order to support such refactoring. In other words, the present invention makes it possible to effectively test LLM-generated code for memory consumption, so that the language model (e.g., LLM) can generate better, in particular memory-optimized, code.

The present invention enables coverage as a quality measure for generated code, which in turn makes it possible to select better generated code. Such higher-quality code is then easier to test.

The present invention is relevant to any product that is based on automated tests, in particular to dynamic testing methods, and any product that has legacy code or performance issues.

Some terms are used in the present disclosure in the following way.

A “language model” can in particular be a large language model (LLM), neural network, recurrent neural network (RNN), a transformer model, or a code model as a language model specialized for code, or even a very general language model that also comprises code. Also included are computer languages, and codes such as program codes of a computing device such as a computer.

The language of the model can include not only natural languages but also artificial languages, such as programming languages.

In software development, “refactoring” of code refers to improving code structurally while maintaining observable program behavior, i.e., functionality. For example, readability, comprehensibility, maintainability and/or extensibility are to be improved with the aim of reducing the corresponding effort for error analysis and/or functional extensions. Typical refactoring includes e.g. renaming variables to self-explanatory names and/or extracting code parts into separate methods. Refactoring increases the quality of the code and therefore of the software.

“Testing,” “checking” or “comparing the source program code and the target program code” may include: formally checking the same behavior of the source program code and the target program code, for example by means of bounded model checking, tests in the source language, tests on contracts in the source language and/or syntactic and stylistic tests, fuzzing, mutation of the inputs of the test harness, derivation from contracts of the source language and/or the target language and/or derivation from a language model.

A “test harness” or test frame comprises a collection of software and test data used to systematically and automatically test a program under various environmental conditions. A test harness usually comprises a test execution engine, which is responsible for executing the test logic, and a test data repository or database, which contains the test scripts, test programs, and other test resources. Here, the test harness is generated automatically by adding differentiating tests to the database, for example. The test can be started with given or ready-made tests from the test database. The system can also generate tests automatically.

Data can be software code including test cases and harnesses plus additional (natural language) descriptions of the functionality or ranges of validity. In the case of language translation, by way of example, C is described as the source language and Rust as the target language, but other combinations are also possible. The translation from C to Rust is interesting since Rust offers features in the field of safety-critical systems, but a lot of legacy code exists in other languages, especially C. In the case of refactoring, the source language and the target language are the same.

“Memory sanitizer” is a tool that recognizes the use of uninitialized memory. A memory sanitizer can insert additional instructions and/or stores metadata on which it works. The memory sanitizer can recognize the use of uninitialized memory, memory leaks, lack of storage space, hanging or endless loops, and infinite recursion (stack overflows). Other sanitizers also provide e.g. recognition of use-after-free, buffer overflows, data races, deadlocks, int/float overflows or bitwise shifts by an invalid amount.

“Intermediate representation” (IR), in the broadest sense also referred to as intermediate language, is the data structure or code that is generated during a translation process by a compiler or a virtual machine at an abstraction level between the higher-level source language and the generally machine-level target language. The intermediate representation can be used internally by a compiler or a virtual machine to represent the source code.

“Contracts” are part of contract-based programming or of a design according to a contract (“design by contract”). This is a software development concept with the aim of optimizing the interaction of individual program modules by defining formal contracts for the use of interfaces that go beyond their static definition.

The term “codebase” refers to the totality of the source code files belonging to a project as well as any associated configuration files. The codebase may also comprise various other files that are required for the compilation process, such as so-called makefiles.

“Fuzzing” or “fuzz testing” is the automated process of sending randomly generated inputs from a fuzzer to a target or target program and observing the response of the target.

A “fuzzer” or “fuzzing engine” is a program that automatically generates inputs. It is therefore not necessarily connected to the software to be tested, nor is any instrumentation performed either. However, it has the ability to instrument code, generate test cases, and run programs to be tested. Conventional examples are AFL and libFuzzer.

A “fuzz target” is a software program or a function that is to be tested by fuzzing. A key feature of a fuzz target is that it is a binary file, a library, an application programming interface (API), or something else that can process bytes as an input.

“Glue code,” “wrapper,” “harness,” or “fuzz driver” link a fuzzer to a fuzz target.

A “fuzz test” is the combined version of a fuzzer and a fuzz target. A fuzz target can then be instrumented code, at the inputs of which a fuzzer is connected. A fuzz test can be executed. The fuzzer can also start, observe, and stop multiple running fuzz tests (generally hundreds or thousands per second), each with a somewhat different input generated by the fuzzer.

A “test case” is a specific input and a specific test run from a test harness or a fuzz test. In order to ensure reproducibility, runs of interest (finding new code paths or crashes) are saved. An “instrumentation” is used to make the coverage metric observable, e.g., during compilation. “Instrumentation” is the insertion of instructions into a program in order to obtain feedback about the execution. It is usually realized by the compiler and can describe e.g. the code blocks reached during execution.

Coverage-guided fuzzing uses code coverage information as feedback during fuzzing in order to recognize whether an input has caused the execution of new code paths/blocks.

In “mutation-based fuzzing,” new inputs are created by taking a series of known inputs (corpus) and randomly applying mutations to them.

In “generation-based fuzzing,” new inputs are created from scratch, for example by using input models or input grammars. “Mutator” is a function that takes bytes as an input and outputs a small random mutation of the input.

A “corpus” (plural: corpora) is a set of inputs. Initial inputs are seeds.

### BRIEF DESCRIPTION OF THE DRAWINGS

FIG. 1 is a flowchart illustrating the techniques of an example embodiment of the present invention for improving memory allocation.

FIG. 2 schematically shows a system in which the techniques of an example embodiment of the present invention can be used to improve memory allocation.

FIG. 3 schematically shows a memory sanitizer in which the techniques of an example embodiment of the present invention can be used to improve memory allocation.

FIG. 4 schematically shows a system in which the techniques of an example embodiment of the present invention can be used to improve memory allocation.

FIG. 5 is a flowchart illustrating the techniques of an example embodiment of the present invention for training a language model.

### DETAILED DESCRIPTION OF EXAMPLE EMBODIMENTS

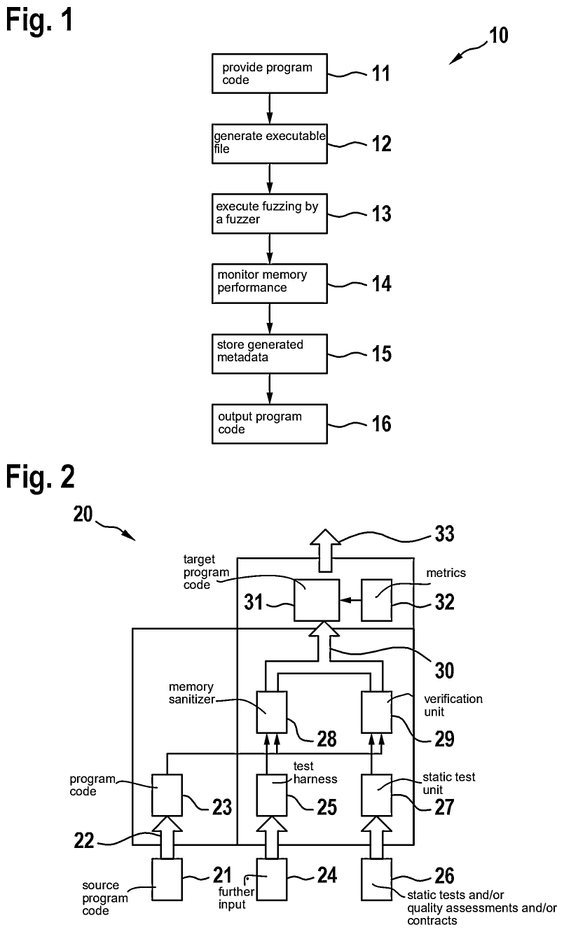

FIG. 1 is a flowchart showing a method 10 for verifying static warnings of code generated by means of a language model. The generated code is generated according to FIG. 1 in an automated program code translation from a source language to a target language. Alternatively, the program code can be generated by code refactoring.

The method 10 provided according to the present invention is aimed at improving the memory allocation of software code generated by means of a language model. The software can be designed to control, regulate and/or monitor a technical system, in particular a cyber-physical system, in particular at least one computing unit of a vehicle. In particular, the software can be embedded software designed to be executed on an embedded (i. e., for example, task-specific) system.

In a first step, a program code that was generated by means of a language model is provided 11. The provision comprises both simply the input of a program code into the method or the system and the inclusion of the generation or language model in the method or system.

If a new version of the program code is available, an executable file is generated 12 by means of compilation and instrumentation, for example by a memory sanitizer, wherein the memory sanitizer inserts instructions into the program code, for example during the generation, or into the executable file during the execution. The sanitizer best inserts its instructions into the intermediate representation in order to support many different languages. A memory sanitizer uses “shadow memory” to initialize and fill the “normal” instructions with variables, and also the information that it is shadow memory. There are then further instructions that implement the method. It is also possible to track which variables with which memory size were allocated and freed at what point. This allows the development of the memory utilization to be tracked. However, the mere number of allocations can also already be interesting.

Optionally, a corpus with inputs for the fuzzer is provided, which contains initial test cases from code repositories of the program code and/or from provided tests and test harnesses. The corpus is initially filled and can be further filled during the method.

This is followed by execution 13 of fuzzing by a fuzzer, wherein the fuzzer injects inputs into the executable file. The aim is to achieve as good a coverage as possible of the file or code through the injected inputs of the fuzzer.

This is followed by monitoring 14 the memory performance (such as memory usage or memory allocation) and optionally runtime information (e.g., actual runtime per test case), the behavior and/or the output of the executable file. When monitoring, the executable file subjected to the fuzzing and a memory metadata database can be monitored. It may be provided that the memory performance, runtime information, the behavior of the executable file, and/or the output of the executable file are fed back to the fuzzer.

This is followed by storage 15 of metadata generated from the allocated and freed memory in a memory metadata database, wherein the metadata are based on the instructions and are stored when the executable file is generated and/or when the fuzzing is executed. Metadata can thus be generated from the allocated and freed memory of all different versions of the program code and stored in a memory metadata database. This makes it possible to collect and compare the memory behavior across different versions of the program code.

This is followed by outputting 16 the program code if no memory performance degradation or other errors have been found. It may be provided to trigger an abnormal termination of the method during or after the execution of fuzzing if the memory performance is worse than older entries from the memory metadata database.

Optionally, static tests can be carried out in parallel with the fuzzing or the executions in the memory sanitizer. Static tests or checks may include, for example:
Contracts are either specified or extracted from the system environment.
In the case of Rust, static checks can also be provided by the compiler in other languages, e.g. also by linters, etc.
Bounded model checking and/or abstract interpretation, realized in commercial tools such as Astrée, or open source tools, such as CBMC.
Automatic creation of a bounded model checking setup, which statically compares target program code to given contracts.
Automatic creation of an abstract interpretation setup, which statically compares target program code to given contracts.
Automatic creation of a bounded model checking setup, which checks the source program code and the target program code for functional equality.

According to an embodiment, the method furthermore comprises updating the program code or parts of the program code using the memory performance, runtime information, the behavior of the program code, and/or the output of the program code, and wherein the updated program code is optionally fed back as an input for the language model.

As an alternative to the translation described, refactoring of the program code may be provided. Refactoring the program code can comprise changes to the program code. The refactored program code can likewise again be a code of the software, in particular a source code of the software.

FIG. 2 schematically shows a computer system 20 in which the techniques of the present invention can be used to improve the memory allocation of code generated by means of a language model. The computer system 20 is designed to execute the method 10 according to FIG. 1 and the method 50 according to FIG. 5. The computer system 20 can be realized in hardware and/or software. Accordingly, the system shown in FIG. 2 can be regarded as a computer program designed to execute the method 10 according to FIG. 1 and the method 50 according to FIG. 5.

A source program code 21 in a source language, such as C, is provided to a language model 22, such as a large language model (LLM), for translation to a target language, such as Rust. The language model 22 generates a (target) program code 23 as a translation of the source program code 21. This area of the computer system 20 can be referred to as the generation area.

The language model is for example a large language model (LLM) into which data, such as a program code here, are inputted together with a question, such as a translation request or refactoring request here, via an input (prompt).

A further input 24 into the system 20 are tests and optionally a test harness in the source language. Alternatively or optionally, the tests and/or the test harness can be available in the target language. These inputs are fed to a test harness 25. The test harness 25 receives functions or tests in the target language.

Optionally, static tests, quality assessments and/or contracts 26 can be fed to a static test unit 27. There, they are managed for subsequent verifications of the program code 23.

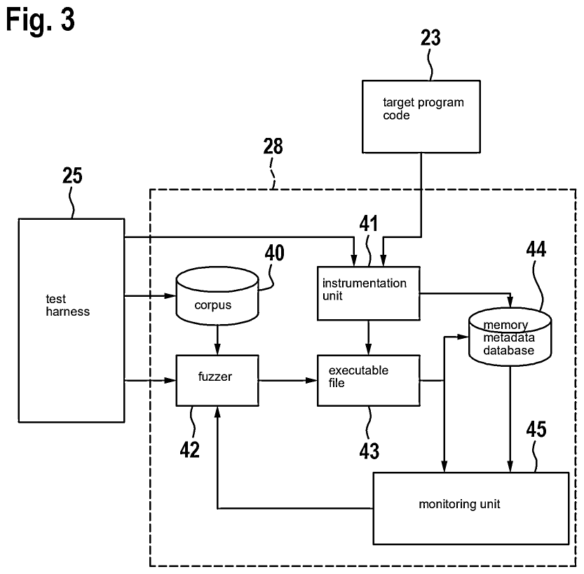

Inputs of a memory sanitizer 28 with fuzzer are linked to the language model 22 for inputting the program code 23 and to the test harness 25 for inputting test routines. In the memory sanitizer 28, the program code 23 is tested on the basis of the test harness 25 with the source program code 21. The memory sanitizer 28 and its function are described in more detail in connection with FIG. 3.

The generation of the program code 23 by the language model 22 can be repeated with changed conditions, such as a change in one or more hyperparameters such as a temperature parameter of the language model, transformations in the source program code and/or changes in the input to the language model, such as changes in the tasks or prompts. Variables in the code can also be renamed.

These measures generate a variance. This variance allows verification and improved quality assessment of the generated translations and also training of the language model by means of feedback. As part of the improved quality assessment, it can be determined which of the generated program codes 23 are more or less suitable. The fuzzer 28 then works with these variants of the program codes 23.

Inputs of a verification unit 29 are linked to the language model 22 for inputting the program code 23 and to the static test unit 27 for inputting static tests, quality assessments and/or contracts 26. In the verification unit 29, the program code 21 is verified by means of the static tests, quality assessments and/or contracts 26.

If the verifications in the memory sanitizer 28 and in the verification unit 29 are completed successfully, a status message 30 is output that the program code 23 is OK. This area of the computer system 20 can be referred to as the verification area.

The target program code 31 can be assessed in terms of its grade on the basis of metrics 32. The metrics 32 can comprise code quality metrics, test quality metrics, and/or the number of tests.

If the assessment is successful, the program code and its quality or grade are output as an output 33. This area of the computer system 20 can be referred to as the quality assessment area.

Based on the assessment, a grade can be calculated. If multiple target program codes have been generated, the solutions can be provided to the user in order by grade.

The assessment of the program code can be carried out for example on the basis of code quality metrics, such as the length of the source code, the number of loops and/or the branch depth, test quality metrics such as the coverage (branch coverage), and/or the number of tests available or carried out.

FIG. 3 shows the memory sanitizer 28 in detail as well as the test harness 25 and the program code 23 as inputs for the memory sanitizer 28.

In order to verify and monitor memory performance, the memory sanitizer 28 comprises the following parts. An (optional) corpus 40 is filled with initial test cases from the code repositories (which are translated or refactored) and/or from the provided tests and test harnesses. For this purpose, the corpus 40 is linked to the test harness 25.

A compilation and instrumentation unit 41 is provided in order to generate an executable file 43 from the program code 23. For this purpose, the unit 41 receives the program code 23 as an input and is linked to the test harness 25 for compilation and instrumentation.

A fuzzer 42 is provided to generate inputs and inject them into the executable file 43. For the inputs, the fuzzer 42 is linked to the corpus 40 and/or the test harness 25.

A memory metadata database 44 is provided for storing metadata. The memory metadata database 44 is generated or initially filled with information from the compilation and instrumentation unit 41. During the runtime, the memory metadata database 44 is filled with the runtime information from the allocated and freed memory for the executable file 43. For this purpose, the memory metadata database 44 is linked to the compilation and instrumentation unit 41 and the executable file 43. The memory metadata database 44 can store metadata from the allocated and freed memory for all different versions of the executable file 43 so that the memory behavior can be considered across different versions.

A monitoring unit 45 measures or monitors the memory performance and optionally runtime information, the behavior and/or the output of the executable file. The coverage of the code can be monitored during the runtime, usually in a gray-box setting. This can then be stored in the monitoring unit 45. All this is fed back to the fuzzer 42 in order to generate better test cases. In addition, the monitoring unit 45 is linked to the memory metadata database 44 in order to obtain information about memory metadata and include them in the monitoring. This can include for example comparisons of memory data such as memory performance, memory allocation, etc.

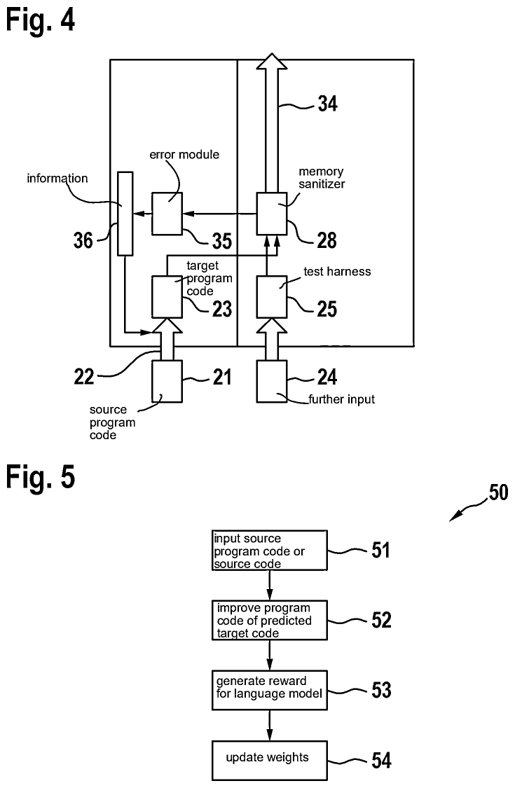

FIG. 4 schematically shows a computer system 20 in which the techniques of the present invention can be used to improve the memory allocation. The computer system 20 can correspond to the computer system 20 of FIG. 2. The computer system 20 is designed to execute the method 10 according to FIG. 1 and the method 50 according to FIG. 5; in particular, the computer system 20 of FIG. 3 is designed to execute the training method 50 according to FIG. 5. The computer system 20 can be realized in hardware and/or software. Accordingly, the system shown in FIG. 3 can be regarded as a computer program designed to execute the method 10 according to FIG. 1 and the method 50 according to FIG. 5.

FIG. 4 shows an error handling mechanism of the computer system 20. If no program code 31 can be generated without errors, this will result in an error in the memory sanitizer 28. Accordingly, a message 34 is output to reduce the confidence in the translation. In addition, the error and the associated program code 31 are stored in an error module 35.

From the error module 35, the best program code so far with the still existing errors is fed back as information 36 to the language model 22 in order to generate a better, ideally error-free target program code therewith. This reduces reliability and is taken into account in the quality determination.

Optionally, this can relate not only to errors in the verification area but also analogously to errors in the quality assessment area.

FIG. 5 is a flowchart illustrating a method 50 for training a language model. The language model is configured to automatically generate program code.

In summary, the code generated by the language model is returned as feedback to the language model in order to generate a new generation of source code. The idea is that already suitable (or better) code can then be fine-tuned with regard to monitoring output and behavior output using an updated prompt that contains the new code. For example, if already good code only has runtime problems at certain points, these points can be fed back to the language model.

In a first step of the method, the source program code or a source code is inputted 51 into a language model and a program code is generated. The language model can already be pre-trained and, where appropriate, also already be fine-tuned. Alternatively, a new, untrained language model can also be used to start with. The training here is based on reinforcement learning. Training takes place in a training environment, for example with PPO (proximal policy optimization).

Furthermore, the program code of the predictive target program code is improved 52 by means of the method 10 as described above with reference to FIG. 1.

A reward is then generated 53 for the language model, wherein the reward is based on the monitoring 14 of the memory performance and optionally runtime information, the behavior and/or the output of the executable file 43 and/or the metadata. For example, a low assessment can result if the memory performance is low and/or if a lot of memory is allocated or little memory is freed. A high assessment can result if the memory performance is high and/or if little memory is allocated or a lot of memory is freed.

Finally, the weights of the language model are updated 54 with the value of the reward. The result of the method is a language model that is better trained on new unlabeled data (here, for example, C code from an engine controller), i.e., provides more reliable translations.

According to an embodiment, the method furthermore comprises approximating the reward by executing only a subset of the tests of the automated checking. This makes it possible to accelerate the training.

What is claimed is:

1. A method for improving memory allocation of code generated using a language model, the method comprising the following steps:
providing a program code generated using a language model, when a new version of the program code is available;
generating an executable file using compilation and instrumentation by a memory sanitizer, wherein the memory sanitizer inserts instructions into the executable file during the generation;
executing fuzzing by a fuzzer, wherein the fuzzer injects inputs into the executable file;
monitoring memory performance;
storing metadata generated from the allocated and freed memory in a memory metadata database, wherein the metadata are based on the instructions and are stored when the executable file is generated and/or when the fuzzing is executed; and
outputting the program code when the fuzzing has not found any memory performance degradation and has not found other errors.

2. The method according to claim 1, wherein the monitoring includes monitoring runtime information, and/or behavior and/or output of the executable file.

3. The method according to claim 1, wherein the instructions are inserted into an intermediate representation of the executable file.

4. The method according to claim 1, wherein a corpus with inputs for the fuzzer is provided, which contains initial test cases:
(i) from code repositories of the program code and/or (ii) from provided tests and test harnesses.

5. The method according to claim 1, wherein an abnormal termination of the method is triggered during or after the execution of fuzzing when the memory performance is worse than older entries from the memory metadata database.

6. The method according to claim 1, wherein, for the monitoring, the executable file subjected to fuzzing and the memory metadata database are monitored.

7. The method according to claim 1, wherein the memory performance, and/or runtime information, and/or behavior of the executable file and/or output of the executable file, are fed back to the fuzzer.

8. The method according to claim 1, wherein the program code or parts of the program code are updated using the memory performance, and/or runtime information, and/or behavior of the program code and/or output of the program code.

9. The method according to claim 8, wherein the updated program code is fed back as an input for the language model.

10. A method for training a language model configured to automatically generate program code, the method comprising the following steps:
inputting a source code into a language model and generating a program code;
improving the program code by:
generating an executable file using compilation and instrumentation by a memory sanitizer, wherein the memory sanitizer inserts instructions into the executable file during the generation,
executing fuzzing by a fuzzer, wherein the fuzzer injects inputs into the executable file;
monitoring memory performance,
storing metadata generated from the allocated and freed memory in a memory metadata database, wherein the metadata are based on the instructions and are stored when the executable file is generated and/or when the fuzzing is executed, and
outputting the program code when the fuzzing has not found any memory performance degradation and has not found other errors;
generating a reward for the language model, wherein the reward is based on the monitoring of the memory performance; and
updating weights of the language model with a value of the reward.

11. The method according to claim 10, wherein the reward is approximated by performing only one verification.

12. A computer system configured to improve memory allocation of code generated using a language model, the computer system configured to:
provide a program code generated using a language model, when a new version of the program code is available;
generate an executable file using compilation and instrumentation by a memory sanitizer, wherein the memory sanitizer inserts instructions into the executable file during the generation;
execute fuzzing by a fuzzer, wherein the fuzzer injects inputs into the executable file;
monitor memory performance;
store metadata generated from the allocated and freed memory in a memory metadata database, wherein the metadata are based on the instructions and are stored when the executable file is generated and/or when the fuzzing is executed; and
output the program code when the fuzzing has not found any memory performance degradation and has not found other errors.

13. A non-transitory computer-readable medium on which is stored a computer program improving memory allocation of code generated using a language model, the computer program, when executed by a computer, causing the computer to perform the following steps:
providing a program code generated using a language model, when a new version of the program code is available;
generating an executable file using compilation and instrumentation by a memory sanitizer, wherein the memory sanitizer inserts instructions into the executable file during the generation;
executing fuzzing by a fuzzer, wherein the fuzzer injects inputs into the executable file;
monitoring memory performance;
storing metadata generated from the allocated and freed memory in a memory metadata database, wherein the metadata are based on the instructions and are stored when the executable file is generated and/or when the fuzzing is executed; and
outputting the program code when the fuzzing has not found any memory performance degradation and has not found other errors.
